(19) United States
(12) Patent Application Publication
(10) Pub. No.: US 2008/0169409 A1
(43) Pub. Date: Jul. 17, 2008

(54) Fixing bracket for preventing release of gear shafts of transmission

(75) Inventor: Heon Kyu Kim, Seoul (KR)

Correspondence Address: MCDERMOTT WILL & EMERY LLP, 600 13TH STREET, N.W., WASHINGTON, DC, 20005-3096, US

(73) Assignee: WONTECH CO., LTD.

(21) Appl. No.: 12/007,416

(22) Filed: Jan. 10, 2008

(30) Foreign Application Priority Data
Jan. 11, 2007 (KR) KR10-2007-0003112

(51) Int. Cl. F16B 1/00

(52) U.S. Cl. 248/674

(57) ABSTRACT

The present invention relates to a fixing bracket for preventing release of gear shafts in a transmission that is provided between the gears fitted around the middle portions of a driving shaft and a driven shaft in the transmission in such a manner as to be insertedly fitted around the driving shaft and the driven shaft, wherein the upper and lower portions of the fixing bracket are connected by means of a connection part, upper and lower through-holes formed in the fixing bracket are adapted to insert the driving shaft and the driven shaft thereinto, and bearings are formed along the inner peripheries of the upper and lower through-holes, thereby greatly reducing the interference occurring during a high-speed rotation of the driving shaft and the driven shaft.

### BACKGROUND OF THE INVENTION

1. Field of the Invention

The present invention relates to a fixing bracket for preventing release of gear shafts in a transmission that has a bearing mounted inside a through-hole formed to insert each of a driving shaft and a driven shaft thereinto, thereby greatly reducing the interference occurring during a high-speed rotation of the driving shaft and the driven shaft and greatly minimizing the vibration widths generated from the driving shaft and the driven shaft so as to suppress the generation of the vibration and noise caused from the rotation of the driving shaft and the driven shaft.

2. Background of the Related Art

Generally, bending vibrations in a drive train for a vehicle are generated when a quantity of dynamic unbalance of the drive train generated by the rotation of the drive train is acted as an excitation source thereof, and the resonance is generated when a bending natural frequency is the same as the revolutions in the drive train.

Torsional vibrations are generated when the transmission of uneven driving forces is acted as an excitation source thereof, and the resonance is generated when the main order of the revolution frequency of the drive train is the same as the natural frequency of the drive train. The bending and torsional vibrations in the drive train are first transmitted to a center bearing, front and rear shaft-support rods, and a frame, and next, the frame vibrations are transmitted through a cap to a vehicle driver.

During the high-speed rotation of the main shafts of the transmission, especially, the linear shafts have an arc-like shape by the centrifugal force thereof (see FIG. 5).

If the centrifugal force is generated more strongly to any one of the rotating shafts, much load is added to the corresponding shaft, such that vibrations are generated on the gears and bearings fitted around the shaft. This undesirably causes the engaging relation between the bearing and the gear to be deteriorated, thereby generating serious noise and abrasion therebetween. Additionally, there occur some problems that oil is contaminated and the lifespan of the transmission is reduced.

Racing automobiles or motorcycles are rotated momentarily at a high speed at a minute instant upon starting or accelerating, thereby applying an enormous force to the shaft. In this case, noises are generated as well as the cracks occur on the surface of the gear, thereby causing the gear to be broken well. Thus, many studies have been made so as to solve these problems.

As one of the prior arts, for example, there has been disclosed Korean Utility Model Laid-Open Publication No. 1999-23439 wherein a bracket is fixed by means of a coupling means to cross members disposed to be perpendicular to side members provided at the both sides of a frame. Further, a cushion rubber is provided inside the bracket, and a center bearing is provided inside the cushion rubber in such a manner as to abut against the cushion rubber and to protect the middle portion of the propeller shaft, while being fixed by means of a fixing means in three directions having equal intervals to one another, wherein the bracket and the cushion rubber mounted inside the bracket are adapted to mount the propeller shaft of a semi-spherical truck thereinto.

As another prior art, there has been disclosed Korean Utility Model Registration No. 0118462 wherein a double vibration-absorbing structure for reducing vibration and noise generated in a transmission for a vehicle. In more detail, an auxiliary rubber is inserted into a coupling hole formed at the both ends of the upper portion of a bracket, and then, the bracket is assembled to a frame, such that the vibration and noise generated in the transmission is not transmitted to the frame, thereby achieving the reduction of the vibration of the vehicle body and the weakening of the noise of the vehicle body to improve the driving comfortability.

As another prior art, further, there has been disclosed Korean Utility Model Registration No. 20-153108 wherein a transmission-mounting bracket has a mounting flange adapted to support the side portions of a transmission, and an engine mounting bracket has a reinforcing structure having a reinforcing rib extended from the body of the transmission-mounting bracket to one side of the mounting flange so as to apply a reaction force against a predetermined rotation moment of the transmission.

As another prior art, moreover, there has been disclosed Korean Patent No. 1998-21518 wherein a sliding type reverse gear-operating impact damper mechanism is provided. In more detail, a reverse gear is slid upon manipulation of the reverse gear by a vehicle driver to strike a transmission housing, thereby generating an impact sound therefrom and applying fatigue load to the transmission housing, and a damper mechanism such as a coil spring, a wave washer or the like is mounted on the both sides of the reverse gear shaft or on the reverse gear.

According to the above-mentioned prior arts, however, the front and side brackets are manufactured separately and assembled to each other, thereby increasing the manufacturing costs, and the vibration and noise generated in the transmission are still transmitted to the vehicle body, thereby causing serious vibration and noise in the transmission and reducing the lifespan of the vehicle.

### SUMMARY OF THE INVENTION

Accordingly, the present invention has been made in view of the above-mentioned problems occurring in the prior art, and it is an object of the present invention to provide a fixing bracket for preventing release of gear shafts of a transmission that is disposed around one side of the middle portions of a driving shaft and a driven shaft so as to fix the driving shaft and the driven shaft together thereto, thereby greatly reducing the vibration and noise generated from the shafts.

To accomplish the above object, according to the present invention, there is provided a fixing bracket for preventing release of gear shafts of a transmission that is provided between the gears fitted around the middle portions of a driving shaft and a driven shaft in the transmission in such a manner as to be insertedly fitted around the driving shaft and the driven shaft, wherein the upper and lower portions of the fixing bracket are connected by means of a connection part, upper and lower through-holes formed in the fixing bracket are adapted to insert the driving shaft and the driven shaft thereinto, and bearings are formed along the inner peripheries of the upper and lower through-holes, thereby greatly reducing the interference occurring during a high-speed rotation of the driving shaft and the driven shaft and greatly reducing the vibration widths generated from the driving shaft and the driven shaft so as to suppress the generation of the vibration and noise caused from the rotation of the driving shaft and the driven shaft.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a detailed sectional view showing conventional gear shafts of a transmission;

FIG. 2 is a detailed sectional view showing the gear shafts of a transmission according to the present invention;

FIGS. 3 and 4 are views showing a fixing bracket for preventing the release of the gear shafts of a transmission according to the present invention; and

FIG. 5 is a detailed view showing the vibration generated from the gear shafts of the transmission according to the present invention.

### DETAILED DESCRIPTION OF THE PREFERRED EMBODIMENT

Reference will now be made in detail to the preferred embodiments of the present invention, examples of which are illustrated in the accompanying drawings.

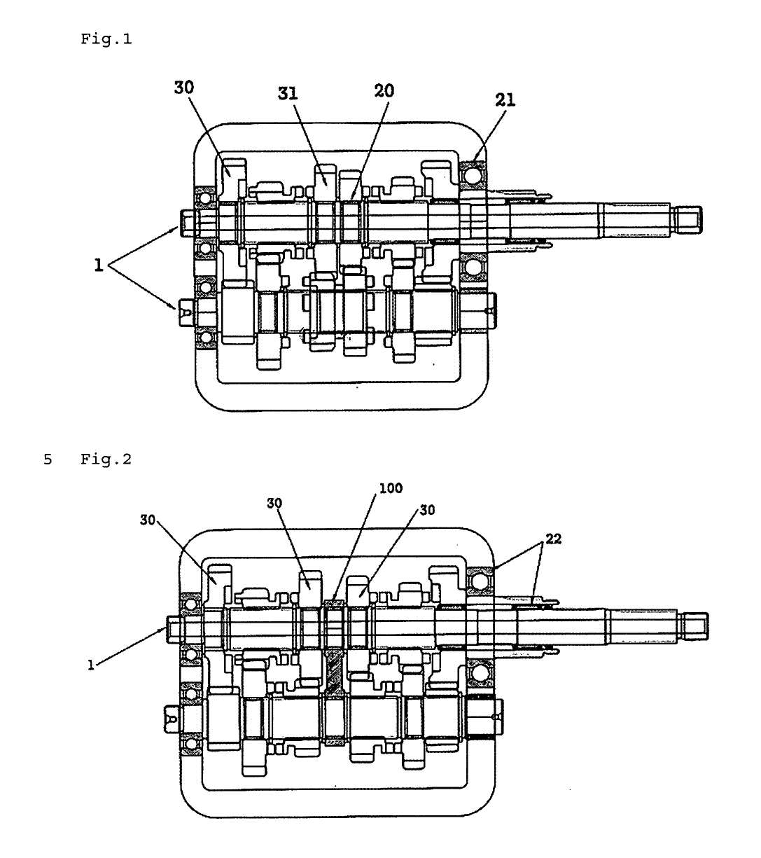

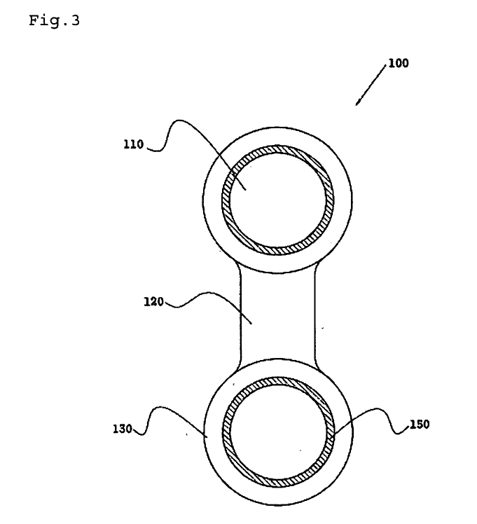

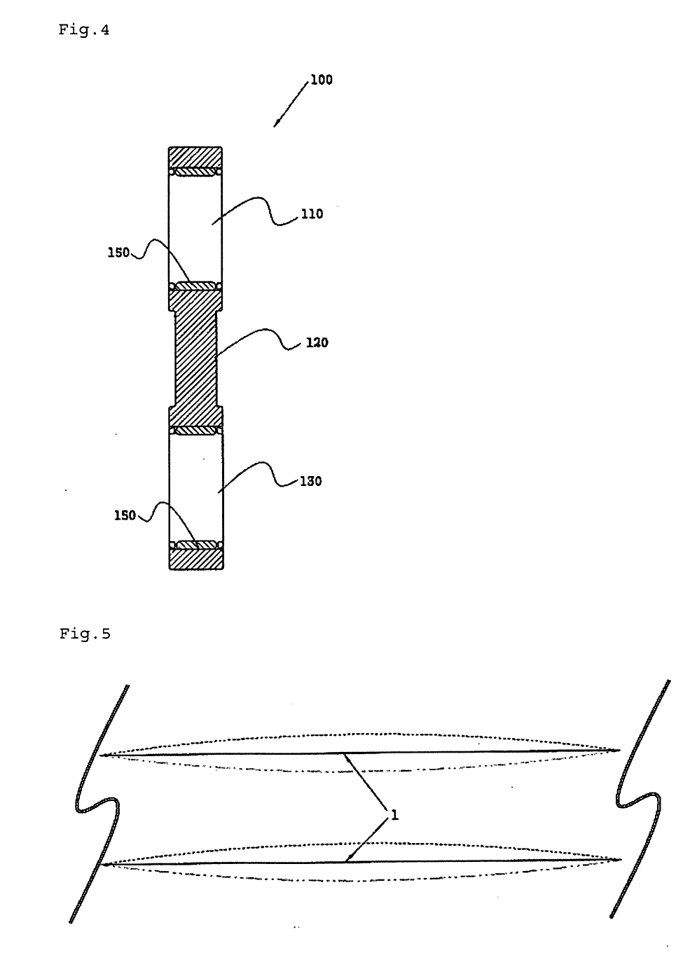

FIG. 1 is a detailed sectional view showing conventional gear shafts of a transmission, FIG. 2 is a detailed sectional view showing the gear shafts of a transmission according to the present invention, FIGS. 3 and 4 are views showing a fixing bracket for preventing the release of the gear shafts of a transmission according to the present invention, and FIG. 5 is a view showing the vibration generated from the gear shafts of the transmission according to the present invention.

As shown in FIGS. 2 to 5, there is provided a fixing bracket 100 for preventing release of gear shafts of a transmission that has a generally ‘8’-like shape, the fixing bracket 100 including: a driving shaft insertion part 110 disposed at the upper side thereof, the driving shaft insertion part having a first through-hole adapted to insert a driving shaft thereinto and a first bearing 150 mounted along the inner periphery of the first through-hole; a connection part 120 provided at the lower portion of the driving shaft insertion part 110; and a driven shaft insertion part 130 provided at the lower portion of the connection part 120, the driven shaft insertion part having a second through-hole adapted to insert a driven shaft thereinto and a second bearing 150 mounted along the inner periphery of the second through-hole.

Now, an explanation on the mounting process of the fixing bracket according to the present invention will be given.

The fixing bracket 100 is provided between the gears fitted around the middle portions of the driving shaft and the driven shaft in the transmission in such a manner as to be insertedly fitted around the driving shaft and the driven shaft, thereby greatly reducing the vibration generated during a high-speed rotation of the driving shaft and the driven shaft, which enables the lifespan of the transmission to be extended longer.

As set forth in the foregoing, there is provided a fixing bracket for preventing release of gear shafts of a transmission that is disposed around the driving and driven shafts to which a substantially stronger centrifugal force is applied in such a manner as to be inserted into each of the driving and driven shafts, thereby preventing the generation of the centrifugal force during the high-speed rotation of the shafts to suppress the vibration and noise generated from the gears and bearings, thereby preventing the formation of cracks caused when the engaging relation between the gears is not good to extend the lifespan of the gears and further the transmission.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A fixing bracket for preventing release of gear shafts of a transmission, the fixing bracket comprising:
a driving shaft insertion part disposed at the upper side of the fixing bracket having a generally ‘8’-like shape, the driving shaft insertion part having a first through-hole adapted to insert a driving shaft thereinto and a first bearing mounted along the inner periphery of the first through-hole;
a connection part provided at the lower portion of the driving shaft insertion part; and
a driven shaft insertion part provided at the lower portion of the connection part, the driven shaft insertion part having a second through-hole adapted to insert a driven shaft thereinto and a second bearing mounted along the inner periphery of the second through-hole.
